(19) United States
(12) Patent Application Publication
(10) Pub. No.: US 2024/0280207 A1
(43) Pub. Date: Aug. 22, 2024

(54) INTERNAL TUBE FOULING SENSORS, SYSTEMS, AND METHODS

(71) Applicant: KAI Systems, Boerne, TX (US)

(72) Inventors: Cody J. Borigo, Palmyra, PA (US); Steven E. Owens, State College, PA (US); Russell Love, State College, PA (US)

(73) Assignee: KAI Systems, Boerne, TX (US)

(21) Appl. No.: 18/584,836

(22) Filed: Feb. 22, 2024

Related U.S. Application Data
(60) Provisional application No. 63/486,325, filed on Feb. 22, 2023.

(51) Int. Cl. F16L 55/40; F16L 101/30

(52) U.S. Cl. CPC F16L 55/40; F16L 2101/30; F28F 2200/00

(57) ABSTRACT

A probe may be configured to be inserted into the bore of a heat exchanger tube and pushed through the length of said tube. The probe may include at least one sensor configured to at least one of detect and quantify internal fouling in said tube without being influenced by the presence of external fouling. The at least sensor may be configured to be in signal communication with a processor and a graphical user interface. Inspection methods and computer-readable media also are disclosed.

### CROSS-REFERENCE TO RELATED APPLICATIONS

This application claims priority to U.S. Provisional Patent Application No. 63/486,325, filed Feb. 22, 2023, the entirety of which is incorporated by reference herein.

### FIELD

The disclosed sensors, systems, and methods relate to the detection, characterization, and quantification of fouling on the internal diameter of tubes, pipes, and other elongate, hollow structures.

### BACKGROUND

Shell and tube heat exchangers are utilized in industrial applications to achieve efficient heat transfer between two fluids in either liquid or gaseous states having different initial temperatures. These types of heat exchangers are common in oil and gas, power generation, and chemical processing facilities. The shell and tube heat exchanger (“heat exchanger”) includes a set of tubes contained within a larger shell vessel. One fluid (e.g., the tube-side fluid) is moved through the tubes while another fluid (e.g., the shell-side fluid) is moved through the shell and across the outer surface of the tubes, thus facilitating heat transfer across the tube wall interfaces. During normal operation, particulate matter, precipitates, and other materials often accumulate on the inner and outer surfaces of the tubes; this is known as “fouling”. The presence of fouling on the tube surfaces reduces the efficiency of the heat exchanger by detrimentally reducing flow and heat transfer. Therefore, regular maintenance of these heat exchangers includes cleaning the inside and outside of the tubes with high-pressure cleaning solutions to remove accumulated fouling.

Fouling removal from the tubes' inner surfaces is also important for facilitating non-destructive testing of the tubes using various means for the purpose of detecting corrosion, erosion, cracking, and other flaws that may threaten the mechanical integrity of the heat exchanger. Typical non-destructive testing methods such as eddy current and ultrasonic testing methods require the fouling to be removed from the surface to provide room for the test probes to be inserted and moved along the length of the tubes; residual fouling can block the probes and negatively affect the accuracy of the flaw detection data.

Even small amounts of residual fouling, with thickness in the thousandths or an inch range, can negatively affect heat transfer and subsequent non-destructive testing. Therefore, the objective during tube cleaning is to remove 100% of fouling on the tube surfaces. Operating the tube cleaning equipment may include controlling flow rates, pressures, and feed speeds, and the operators generally attempt to utilize the lowest flow rates, lowest pressures, and highest feed rate possible to minimize the generation of contaminated fluid, reduce the possibility of damaging the tube bundle, while minimizing the cleaning time. In order to make this process as efficient as possible and to verify that the cleaning is acceptable, a method of efficient and accurate fouling assessment would be advantageous. However, assessing the efficacy of fouling removal is a challenge due to the limited accessibility of the inner tube surfaces. Since the process and requirements for cleaning the outer surfaces and the inner surfaces of heat exchanger tubes are different, the assessment of the fouling on these two surfaces of the tubes should be independent of one another. The presence of external fouling cannot influence the assessment of internal fouling, as this would lead to improper decision making regarding internal cleaning of the tube, and vice versa.

A system and method capable of traversing the length of the tubes and rapidly quantifying the presence of inner surface residual fouling along the lengths of said tubes would provide highly valuable feedback during or following tube cleaning. Cleaning system operators could utilize this information to determine whether or not the tube meets the minimum acceptable criteria for fouling removal, and for tubes that fail these criteria, the operator could target the specific areas of unacceptable residual fouling and tune the cleaning parameters according to the remaining fouling thickness.

### SUMMARY

A probe is disclosed that contains at least one sensor designed to measure the presence and thickness of internal fouling in a heat exchanger tube. The probe is designed to be inserted into the bore of said tube and moved along its length. A method is disclosed for employing a probe to collect and process data to create an image of fouling in the tube.

In some embodiments, a system may include a sensor. The sensor may include a body sized and configured to be received in a tube The body may support at least one sensor configured to obtain data representing a fouling of an inner surface of the tube.

In some embodiments, the at least one sensor may include at least one of a capacitive sensor, a contact displacement sensor, a conductivity sensor, and an optical distance sensor.

In some embodiments, the tube may be part of a heat exchanger.

In some embodiments, the system may include a processor in communication with the at least one sensor. The processor may be configured to receive the data representing a fouling of the inner surface of the tube from the at least one sensor and determine a fouling level of the inner surface of the tube based on the data.

In some embodiments, the processor may be configured to determine the fouling level without being influenced by the presence of fouling on an exterior surface of the tube.

In some embodiments, a system for detecting fouling may include a probe and a cable configured to be coupled to the probe. The probe may include a body sized and configured to be received in a tube to be inspected. A plurality of sensors may be supported by the body. Each sensor of the plurality of sensors may be configured to obtain data representing a fouling of an inner surface of the tube.

In some embodiments, the probe may include at least one centering mechanism configured to contact an inner surface of the tube to be inspected.

In some embodiments, the at least one centering mechanism includes a plurality of wheels that are biased to extend outwardly from the body of the probe.

In some embodiments, the at least one centering mechanism may include at least one contact-type displacement sensor extending outwardly from the body of the probe.

In some embodiments, the body of the probe may have a cylindrical shape and include a front face having an outer diameter that is less than a maximum outer diameter of the body of the probe.

In some embodiments, the body may include a front edge disposed between the front face and the maximum outer diameter of the body.

In some embodiments, the cable may configured to be coupled to the probe at an end that is opposite the front face.

In some embodiments, the cable may be sufficiently rigid to advance the probe at least partially along a length of the tube to be inspected.

In some embodiments, the plurality of sensors may include at least one optical sensor. The at least one optical distance sensor may be supported by the body of the probe such that the a least one optical distance sensor may be configured to measure a distance from the optical distance sensor to at least one of an inner surface of the tube to be inspected or a fouling disposed on a surface of the tube to be inspected.

In some embodiments, the system may include a controller disposed in signal communication with the plurality of sensors. The controller may include a processor configured to receive signals from the plurality of sensors and determine an amount of fouling present on the inner surface of the tube to be inspected.

In some embodiments, the cable may be configured to transmit signals between the plurality of sensors and the controller.

In some embodiments, the processor may be configured to generate at least one fouling image and cause the at least one fouling image to be displayed. The fouling image may be displayed on a display device. The display device may be part of or in signal communication with the controller.

In some embodiments, a method may include receiving, by a processor of a controller, first data from at least one sensor supported by a body of a probe. The first data may be acquired by the at least one sensor when the probe is disposed within a tube and located at a first location along a length of the tube. The method may include quantifying, by the processor based on the first data received from the at least one sensor, an amount of fouling present at the first location along the length of the tube. The method may include storing data indicative of the amount of fouling present at the first location along the length of the tube in a memory.

In some embodiments, the method may include comparing, by the processor, the first data indicative of the amount of fouling present at the first location along the length of the tube to at least one threshold and determining whether the tube needs to be cleaned based on the comparing.

In some embodiments, the method may include generating, by the processor based at least in part on the first data, at least one fouling image and causing the at least one fouling image to be displayed.

In some embodiments, the method may include receiving, by the processor, second data from the at least one sensor supported by the body of the probe. The second data may be acquired by the at least one sensor when the probe is disposed within the tube and located at a second location along the length of the tube. The second location may be different from the first location. In some embodiments, the second location and the first location may be the same location.

The method may include quantifying, by the processor based on the second data received from the at least one sensor, an amount of fouling present at the second location along the length of the tube and comparing, by the processor, the second data indicative of the amount of fouling present at the second location along the length of the tube to the at least one threshold.

The method may include determining whether the tube needs to be cleaned based on the comparing of the second data to the at least one threshold.

In some embodiments, a computer-readable storage medium may be encoded with program code. The program code, when executed by a processor, may perform a method. The method may include receiving, by a processor of a controller, first data from at least one sensor supported by a body of a probe. The first data may be acquired by the at least one sensor when the probe is disposed within a tube and located at a first location along a length of the tube. The method may include quantifying, by the processor based on the first data received from the at least one sensor, an amount of fouling present at the first location along the length of the tube. The method may include storing data indicative of the amount of fouling present at the first location along the length of the tube in a memory.

### BRIEF DESCRIPTION OF THE DRAWINGS

FIG. 1 is an isometric view of a shell and tube heat exchanger.

FIG. 2 is a cross-sectional view of a heat exchanger tube with internal and external fouling.

FIG. 3A is an illustration of a capacitive proximity sensor separated from a tube surface.

FIG. 3B is an illustration of a capacitive proximity sensor in contact with fouling on a tube surface.

FIG. 3C is an illustration of a capacitive proximity sensor separated from fouling on a tube surface.

FIG. 4A is an illustration of a contact displacement sensor in contact with a tube surface.

FIG. 4B is an illustration of a contact displacement sensor in contact with fouling on a tube surface.

FIG. 5A is an illustration of an optical distance sensor in proximity to a tube surface.

FIG. 5B is an illustration of an optical distance sensor in proximity to a tube surface with fouling.

FIG. 6A is an illustration of a continuity sensor with two probes in contact with a tube surface.

FIG. 6B is an illustration of a continuity sensor with two probes in contact with fouling and a tube surface.

FIG. 7A is an isometric view of a probe with a centering mechanism and point capacitive sensors.

FIG. 7B is an isometric view of a probe with contact displacement sensors and area capacitive sensors.

FIG. 7C is an illustration of a redirection mechanism implemented in conjunction with a displacement sensor in a probe.

FIG. 7D is an isometric view of a probe with a centering mechanism and an optical distance sensor.

FIG. 7E is an isometric view of a probe with a plurality of centering mechanisms, an optical distance sensor, and a gear.

FIG. 8 is a flow chart of a first method for quantifying fouling in a tube.

FIG. 9 is a flow chart of a second method for quantifying fouling in a tube.

FIG. 10 is a block diagram of the relationship between several components of a system including a probe and a processor.

### DETAILED DESCRIPTION

This description of the exemplary embodiments is non-limiting and is intended to be read in connection with the accompanying drawings, which are to be considered part of the entire written description.

Systems and methods are disclosed for the detection and quantification of residual fouling on the inner surface of heat exchanger tubes. In some embodiments, the disclosed systems may include at least one of an electrical resistance sensor, a mechanical displacement sensor, and a capacitance sensor that are configured to be inserted in the interior of a heat exchanger tube and moved along the length of said tube to characterize the fouling condition as a function of axial (or linear) location along a length of a tube, and in some embodiments, a circumferential location as well. The disclosed methods may include inserting at least one disclosed sensor by means of a probe within a heat exchanger tube, gathering the data provided by the disclosed sensors, processing and integrating said data from each sensor, and generating an estimate of an amount residual fouling on the tube inner surface as a function of position in the tube. Additionally, some of the disclosed methods may include further utilizing this residual fouling detection process in a feedback loop with a tube cleaning process.

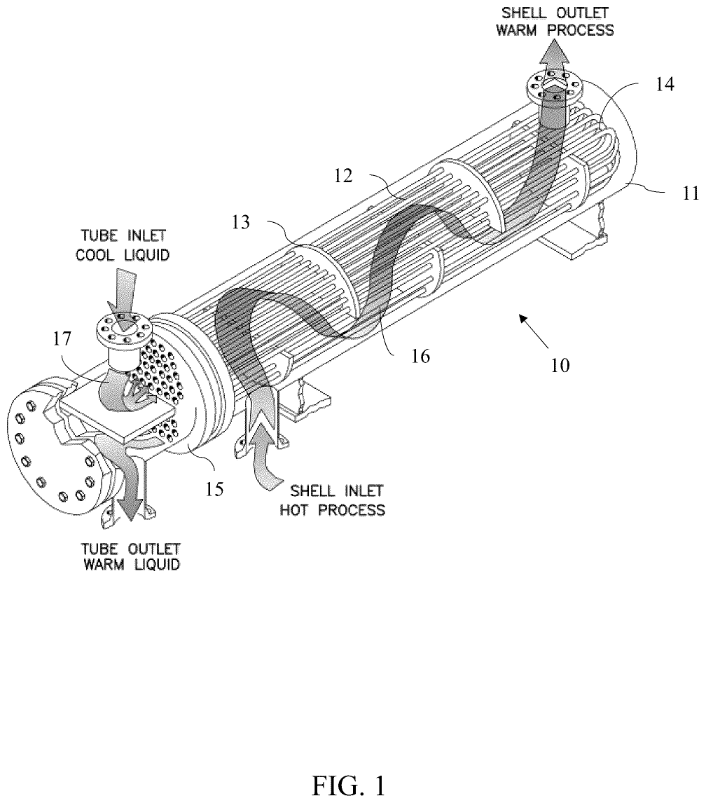

One example of a typical shell and tube heat exchanger 10 is illustrated in FIG. 1, in which a plurality of tubes 12 are contained within a shell 11. Baffles 13 may separate and support said tubes and direct the flow of the shell-side fluid 16 through the shell 11 and across the outer surfaces of the tubes 12. The tubes 12 may be attached to at least one tube sheet 15 and in some embodiments include U-bends 14. The tube-side fluid 17 passes through tubes 12. The heat exchanger 10 allows for efficient heat transfer between fluids 16 and 17 across the tube wall interfaces. Build-up of material on these interfaces reduces the flow of said fluids and reduces the efficiency of heat transfer between them.

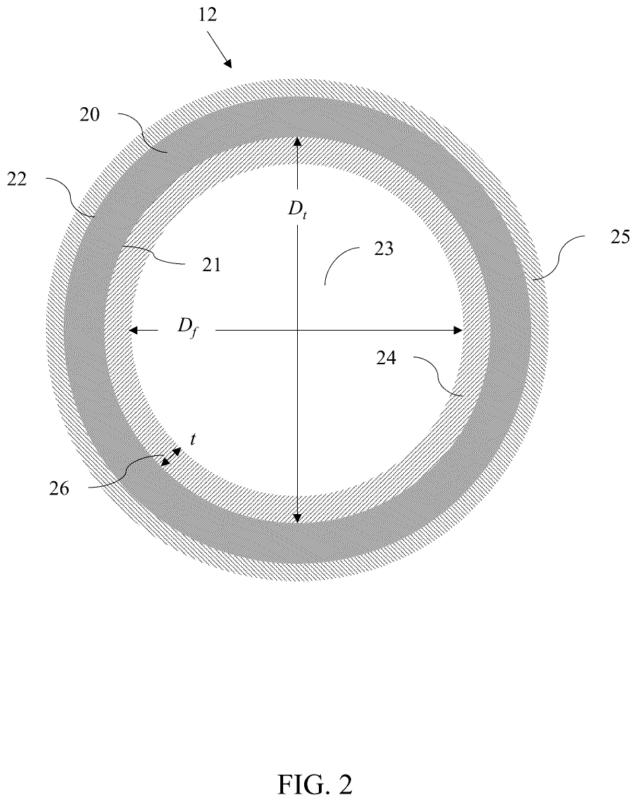

A cross-section of a tube 12 is illustrated in FIG. 2, in which the tube wall 20 is defined by an outer surface 22 and an inner surface 21. The bore 23 is the space within the tube 12 through which tube-side fluid 17 passes. The inner diameter of tube 12 is represented by Dₜ. Fouling can accumulate on both surfaces 21 and 22 of tube 12 during normal heat exchanger operation due to precipitation, particulate matter accumulation, corrosion, encrustation, scaling, biofouling, and other causes. Internal fouling 24 accumulates on inner surface 21 with a thickness 26, signified by t, thus defining a reduced diameter for tube-side fluid flow signified by D_{f}. Generally, the thickness 26 of fouling 24 varies along the length and around the circumference of each tube 12. Furthermore, external fouling 25 accumulates on outer surface 22.

One type of sensor that can be used to detect the distance to a target is a capacitive proximity sensor. In general, a capacitor comprises a pair conductive plates that are configured parallel to one another and are separated by a dielectric. Capacitive proximity sensors, which are used for detecting distance to targets in industrial processes and used in touch sensor applications, among others, operate by detecting changes in current through an oscillator circuit connected to one or more conductive electrodes in the sensor head. The oscillator circuit causes an electric field to be emitted from these one or more electrodes; this field extends beyond the sensor head and into the sensing area. When a conductive, or in some cases, a non-conductive object, known as the “target”, is placed within the sensing area, it interferes with the electric field, thereby increasing the overall capacitance and increasing the current through the oscillator circuit. The electrical properties and the proximity of the target both affect the response in the oscillator circuit. Furthermore, changes in the dielectric properties of any materials existing between the sensor and the target, e.g., coatings or contaminants, will also impact the response through the oscillator circuit.

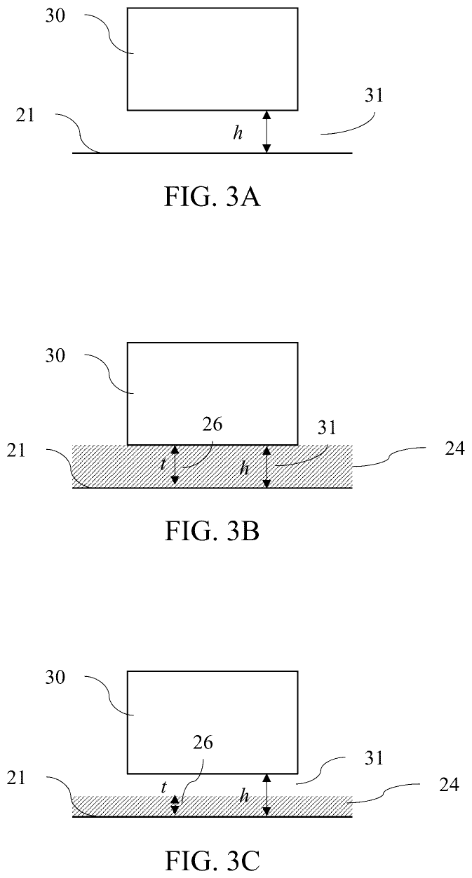

In FIG. 3A, a capacitive sensor 30 is shown being disposed in proximity to a metallic inner surface 21 of a heat exchanger tube 12. The capacitive sensor 30 may be separated from the surface 21 by a gap 31, the size of this gap being denoted by h. As the size h of the gap 31 is decreased, the electrical response in capacitive sensor 30 increases. If sensor 30 is appropriately calibrated, the size h of gap 31 can be determined.

In FIG. 3B, internal fouling 24 is present on inner tube surface 21 with a thickness 26, denoted by t, and capacitive sensor 30 may be configured to be in direct contact with fouling 24. In this example, the size h of the gap 31 between sensor 30 and inner tube surface 21 is equal to the fouling thickness, i.e., h=t. However, due to the difference in the dielectric properties of fouling 24 present in gap 31 in FIG. 3B and the air present in gap 31 in FIG. 3A, the response in the electrical response by sensor 30 will be different. Generally speaking, capacitance is inversely proportional to the dielectric constant of the material between the electrodes of the capacitive sensor 30.

In FIG. 3C, the size h of the gap 31 between the capacitive sensor 30 and the inner tube surface 21 is greater than the thickness 26 of internal fouling 24. Based on the same principles described in reference to FIG. 3B, the electrical response of the capacitive sensor 30 will vary from the responses anticipated by the scenarios illustrated in FIGS. 3A and 3B.

A displacement sensor is a device that can be used to measure a change in physical position, generally along a single axis. Displacement sensors may be used in many industries and applications and are often utilized to measure a change in position of an object. Displacement sensors can also be employed to measure a relative distance between the sensor and an object. Displacement sensors can take many forms and can operate using various principles, including contact and non-contact varieties. Several types of contact displacement sensors include linear variable differential transformer (LVDT), linear variable inductance transducer (LVIT), draw-wire, and more. Various displacement sensors could be implemented in the design of the disclosed internal fouling probe.

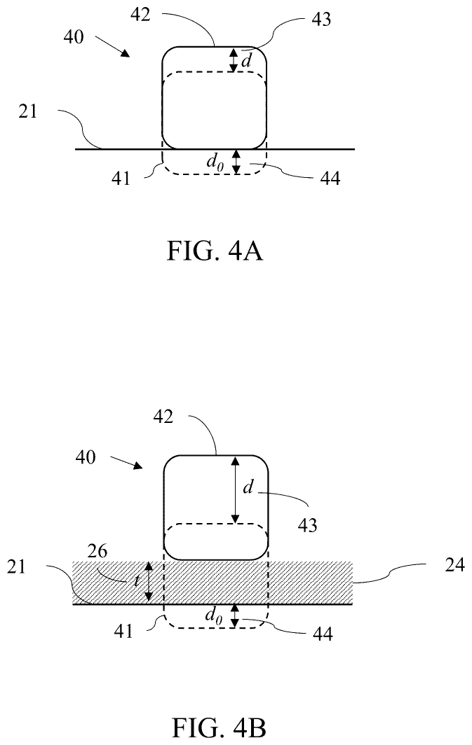

In FIG. 4A, a contact displacement sensor 40 is disposed in proximity to inner tube surface 21. The initial position 41 and secondary position 42 of said contact displacement sensor 40 may yield a relative displacement 43, denoted by d. In the scenario illustrated in FIG. 4A, the initial position 41 of the displacement sensor 40 may be below surface 21 by a distance 44 denoted by d₀, such that d=d₀. Based on this displacement measurement, the relative position of surface 21 to the initial position 41 of sensor 40 can be determined.

In FIG. 4B, the presence of internal fouling 24, having a thickness 26 denoted by t, induces a displacement 43 denoted by d such that d=d₀+t. Based on this displacement measurement, the relative position of surface 21 to the initial position 41 of sensor 40 can be determined and the thickness 26 of fouling layer 24 can also be determined.

In addition to contact-type displacement sensors, non-contact type displacement sensors are also widely available. Optical displacement sensors emit light upon the target surface and analyze the reflected signal to determine the distance from sensor to target. Optical displacement sensors can use various sensing methods, including laser interferometers, laser triangulation systems, radar, lidar, fiber optic intensity-based sensors, and confocal sensors. For the purposes of internal tube fouling measurement, confocal sensors are one applicable non-contact optical displacement sensing technology. Confocal sensors come in monochromatic and polychromatic forms, with the latter providing better range and resolution. Monochromatic confocal sensors provide highly-accurate distance measurements by measuring distance relative to a known focal point of monochromatic light emitted through a lens, onto the target surface, and then reflected back through the lens to a photodetector. Polychromatic confocal sensing applied the same principle but with broadband light, which, due to chromatic dispersion of the optics, will provide a range of focal points for the various wavelengths of light. The confocally backscattered light can then by spectrally analyzed and the target distance can be determined with high accuracy. Since an optical fiber can be used as the light source, confocal sensors can be designed to fit into small spaces and the apertures can be located at 90 degrees (or other angles) relative to the probe length for inserting into small bores. This is another advantage of implementing this type of optical displacement sensor for internal tube fouling.

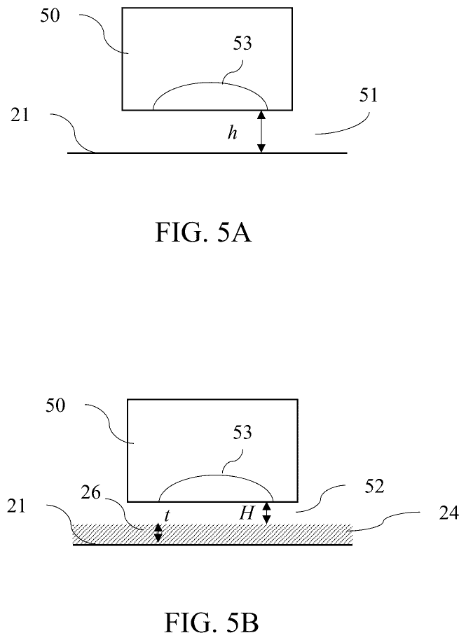

In FIG. 5A, a non-contact, optical displacement sensor 50 is disposed in proximity to inner tube surface 21 with an optical aperture 53 disposed approximately perpendicular to and separated from said surface by a gap 51, the distance (or size) of which is denoted by h. In some embodiments, sensor 50 is a monochromatic or polychromatic confocal sensor, and in other embodiments it is a laser-based optical sensor. However, it should be understood that other types of non-contact, optical displacement sensors, including those referenced above, may be used.

In FIG. 5B, a non-contact, optical displacement sensor 50 is disposed in proximity to inner tube surface 21 and internal fouling 24, which has a fouling thickness 26 denoted by t. Optical sensor 50 may be configured with optical aperture 53 disposed perpendicular to or off-axis from the tube axis and separated from fouling layer 24 by a gap 52, having a distance (or size) denoted by H. Therefore, the distance 51 between the optical sensor 50 and inner tube surface 21, denoted by h, would be given by h=t+H.

Another example of a type of sensor that may be used is a conductivity sensor, which measures the electrical conductivity between two electrodes. One form of conductivity sensor that is widely available is in an electrical multimeter and used for electrical continuity checks between two probe electrodes. This type of measurement can be employed to assess the quality of electrical contact and conductivity along the pathway between the two probes.

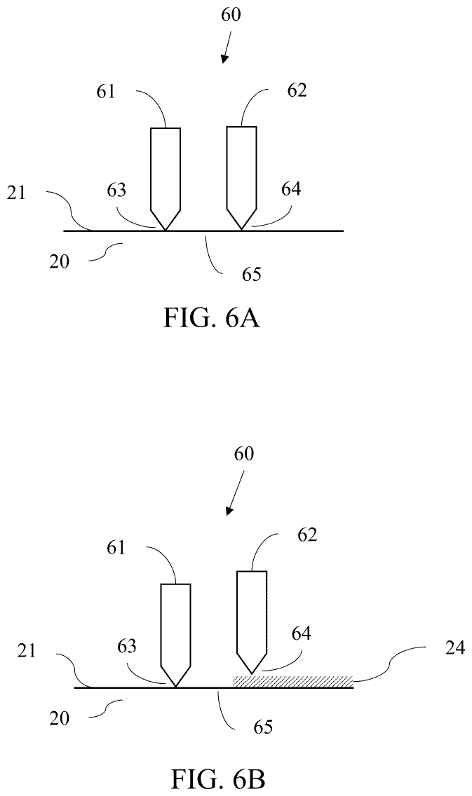

In FIG. 6A, an conductivity sensor 60 comprises a first electrical probe 61 and a second electrical probe 62 that are configured to be disposed on inner tube surface 21 by means of a spring or other force application method. The first probe 61 has at least one first contact point 63 with inner tube surface 21, the second probe 62 has at least one second contact point 64 with inner tube surface 21, with said contact points being separated by an electrical pathway 65 through tube wall 20 and tube inner surface 21. Assuming tube wall 20 is composed of metal and/or other electrically conductive material, the electrical conductivity through pathway 65 should be very high (e.g., less than 100 Ohms) as long as the electrical contacts 63 and 64 are sufficient.

In FIG. 6B, conductivity sensor 60 is disposed in a similar configuration as the configuration illustrated in FIG. 6A, with the exception of the presence of an internal fouling layer 24 that is disposed between (and interfering with) the electrical contact 64 of probe 62 such that a high-conductivity pathway with tube wall 21 cannot be completed. The presence of fouling 24 between at least one of the probes 61 and 62 results in a very low measured electrical conductivity (e.g., an electrical conductivity less than the conductivity of the configuration shown in FIG. 6A). Thereby, conductivity sensor 60 can be utilized to detect the presence of internal fouling 24 on tube surface 21.

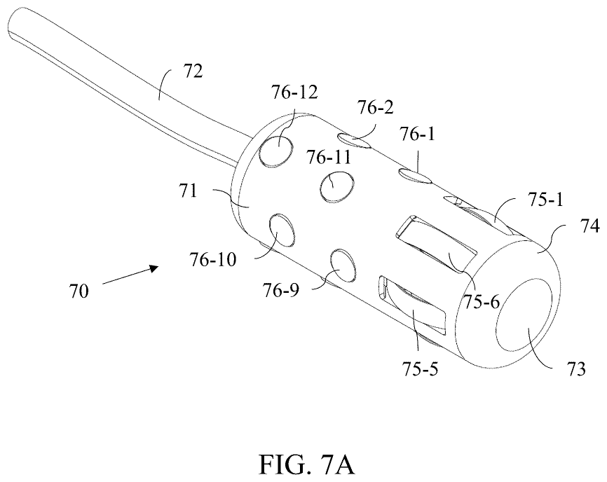

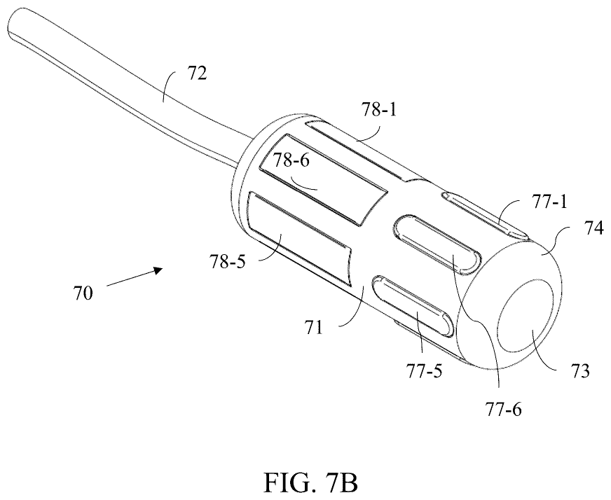

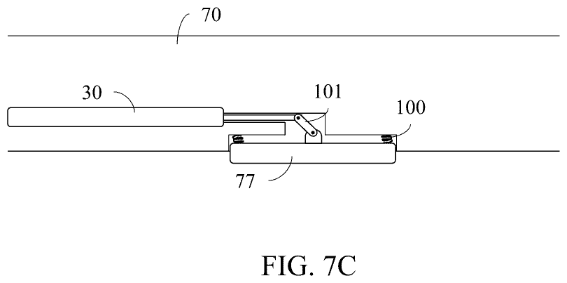

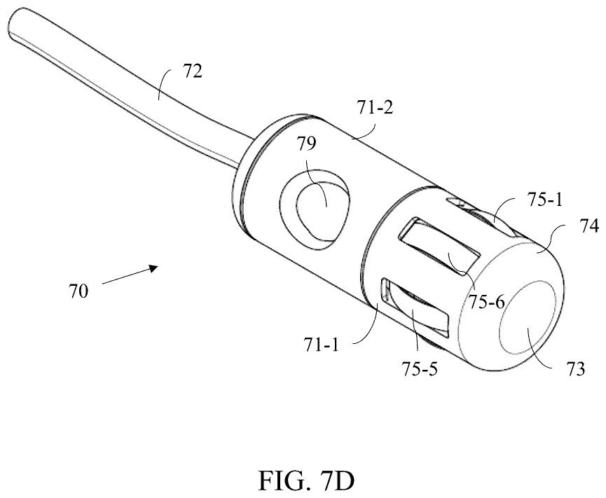

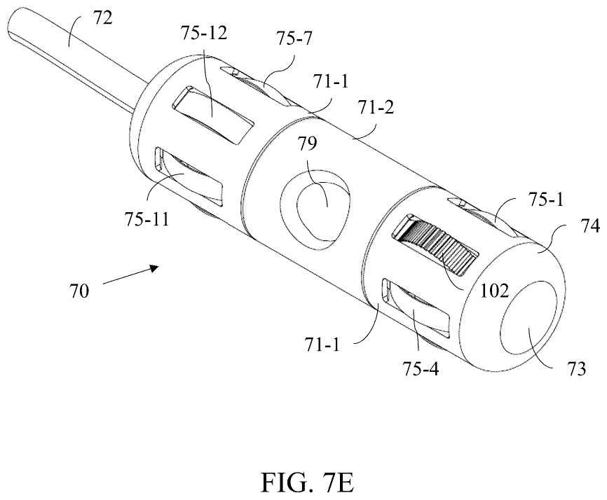

The disclosed internal tube fouling sensor utilizes one or more of the sensors disclosed in FIG. 3A, FIG. 4A, FIG. 5A, and FIG. 6A disposed within or otherwise supported by a probe 70 that is sized and configured to be inserted into a tube 12 and moved along a length of the tube 12 and through the heat exchanger 10. One embodiment of a probe 70 is illustrated in FIG. 7A, in which the probe comprises at least one probe body 71 having a front face 73 with a front edge 74. The diameter of body 71 is designed to fit within a tube bore 23. In some embodiments, the front edge 74 of the body may be tapered and/or curved. For example, the radius of edge 74 is designed to allow probe 70 to move smoothly through the tube 12, even in the presence of fouling 24. For example, the probe 70 may be provided with a front edge 74 having a radius or other geometric feature that reduces the overall diameter of the probe 70, which in turn will reduce the likelihood of the probe 70 being snagged on and/or prevented from proceeding along the tube compared to a straight edge (e.g., an probe without an edge 74).

In the embodiment illustrated in FIG. 7A, probe 70 further comprises a data cable 72 that is sufficiently rigid to push probe 70 through tube 12, at least one centering mechanism 75, and a plurality of point-type capacitive sensors 76 that are distributed around the circumference of probe body 71. In some embodiments, centering mechanisms 75-1, 75-2, etc. may include a plurality of spring-type elements configured to press against inner tube surface 21 or the surface of any internal fouling 24 that may be present in said tube. In some embodiments, the centering mechanism 75-1, 75-2, etc. may include one or more wheels, which may be outwardly biased. In some embodiments, as described below, one or more of the centering mechanisms may include a contact-type displacement sensor.

The embodiment of probe 70 illustrated in FIG. 7A comprises at least one capacitive sensor 76. In this embodiment, capacitive sensors 76 are of the point-sensing type and are designed to cover a small area under the sensing head (e.g., the portion of the probe body 71 carrying the capacitive sensors). By configuring a plurality of point-type capacitive sensors 76-1, 76-2, . . . , 76-12 around the circumference of probe body 71, the fouling 24 can be mapped around the circumference of inner tube surface 21 and along its length as probe 70 moves through and along the tube 12.

In the embodiment illustrated in FIG. 7B, at least one contact-type displacement sensor 77-1, 77-2, . . . , 77-6 is disposed around the circumference of probe body 71 such that the initial position 41 of the face of each sensor will interfere with tube wall 20, thereby ensuring that a measurable displacement is induced on each sensor 77 when probe 70 is inserted into the bore 23 of a tube 12. Displacement sensors 77 may be one of the various types described herein or one of various other types as will be understood to those of ordinary skill in the art. Configuring a plurality of spring-loaded displacement sensors 77 around the circumference of probe 70 also serves as a centering mechanism 75.

Due to the small spatial constraints imposed on probe 70 by the inner diameter of a tube 12, which in many cases can be equal to or less than 0.75 inches, the length of many contact-type displacement sensors may exceed this diameter and thus would not be able to be installed directly in probe 70 in such a form factor. As is illustrated in FIG. 7C, sensors 77 can be designed with a redirection mechanism 101 including, but not limited to, a ramp, cam, linkage, or other mechanical device to allow said displacement sensors to measure displacements perpendicular to their length. In one embodiment, sensor 77 is connected to probe body 70 with one or more springs 100 and is further connected to displacement transducer 30, which may be of the LVDT type, by means of a redirecting linkage 101. Those of ordinary skill in the art will understand that alternative mechanisms for redirecting the displacement can be implemented.

Furthermore, in reference again to FIG. 7B, in some embodiments, probe 70 may comprise at least one area-type capacitive sensor 78-1, 78-2, . . . , 78-6 disposed around the circumference of the probe body 71. Area-type capacitive sensors, in some cases referred to as “gap sensors”, are typically constructed of flexible printed circuits are very low-profile compared to point-type capacitive sensors, which is advantageous for the disclosed application in which the tube diameter inflicts spatial limitation on the diameter of the probe. Area-type capacitive sensors provide an average distance to the target over the sensing area. A plurality of sensors 78 can be used to measure fouling thickness 24 around the circumference of inner tube surface 21 and along its length as the probe 70 is moved through tube 12.

In the embodiment illustrated in FIG. 7D, probe 70 may include a first probe body section 71-1 and at least a second probe body portion 71-2, in which section 71-2 is free to rotate with respect to section 71-1. In this embodiment, probe body section 71-2 further comprises an optical distance sensor 79, which may be of the polychromatic confocal type. It should be understood that other types of optical distance sensors 79, including those described herein, may be used instead of or in addition to a polychromatic confocal sensor. The ability of section 71-2 and optical sensor 79 to rotate allows said scanner (e.g., optical distance sensor 79) to measure the distance to fouling 24 and surface 21 around the full circumference of tube 12 and along the length of said tube as probe 70 is moved.

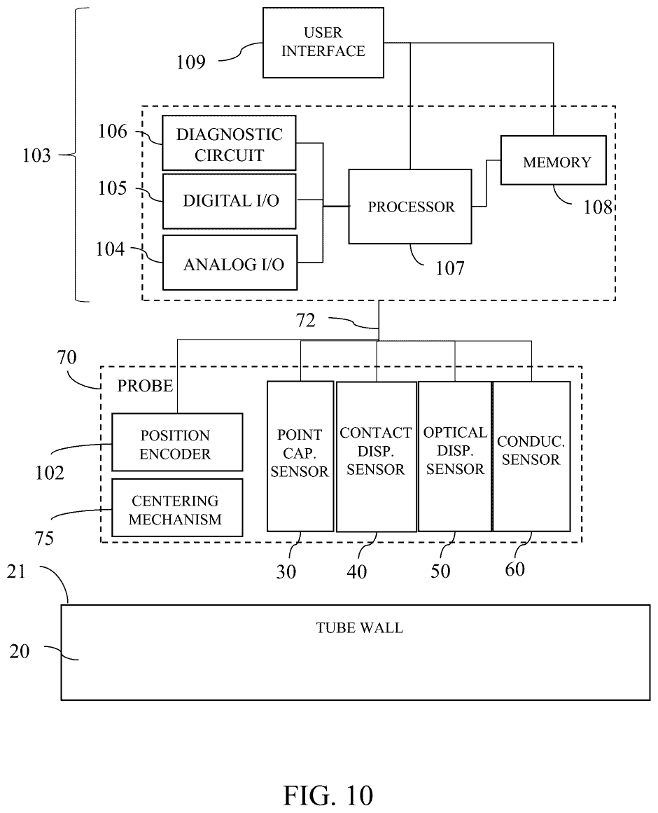

In the embodiment illustrated in FIG. 7E, probe 70 includes at least one additional centering mechanism 75-7, 75-8, . . . , 75-12 configured to be located at the end of probe body 71 opposite front end 73, thereby ensuring the portion of body 71-2 that is between said centering mechanisms is approximately centered in tube 12. FIG. 7E further illustrates a gear 102 that is designed to be in contact with fouling 24 or inner tube surface 21 and is configured to rotate in synchronization with the forward motion of probe 70 through tube 12. Gear 102 can be configured to rotate section 71-2 by mechanical means, including but not limited to a series of gears, as will be understood to those of ordinary skill in the art. Alternatively, gear 102 can be configured to provide an analog or digital signal linearly proportional to or representative of the forward motion of probe 70, which may be used to determine an axial or linear location along a length of the tube. In some embodiments, gear 102 is part of a position encoder, such as position encoder 102 shown in FIG. 10. As will be understood by one of ordinary skill in the art, the position encoder 102 may be configured to transmit a signal to a processor, such as processor 107 shown in FIG. 10, for determining a linear location of the probe along a length of a tube being inspected. The processor 107 may cause the location information to be stored in association with sensor data obtained while the probe is located at the location along the length of a tube being inspected.

In some embodiments, the contact faces of centering mechanism 75 or displacement sensors 77 include bare metal and are configured to be used as a plurality of conductivity probes. By measuring conductivity between at least two of said contact faces, it may be determined whether or not fouling 24 is present between said faces and inner tube surface 21. As described above, high conductivity (e.g., less than 100 Ohms and less than 10 Ohms in some embodiments) between a pair of said probes indicates that they are both in direct contact with surface 21, whereas a comparatively lower conductivity between said probes indicates that at least one is in contact with fouling 24.

In some embodiments, the cable 72 may include a rigid, flexible component that facilitates pushing probe 70 through tube 12, including around a U-bend 14, as illustrated in FIG. 1. Furthermore, in some embodiments, probe 70 may comprise a plurality of probe bodies 71 connected by a semi-rigid components such that each body 71 contains at least one of a centering mechanism 75, a capacitive point sensor 76, a displacement sensor 77, a capacitive area sensor 78, and/or an optical distance sensor 79.

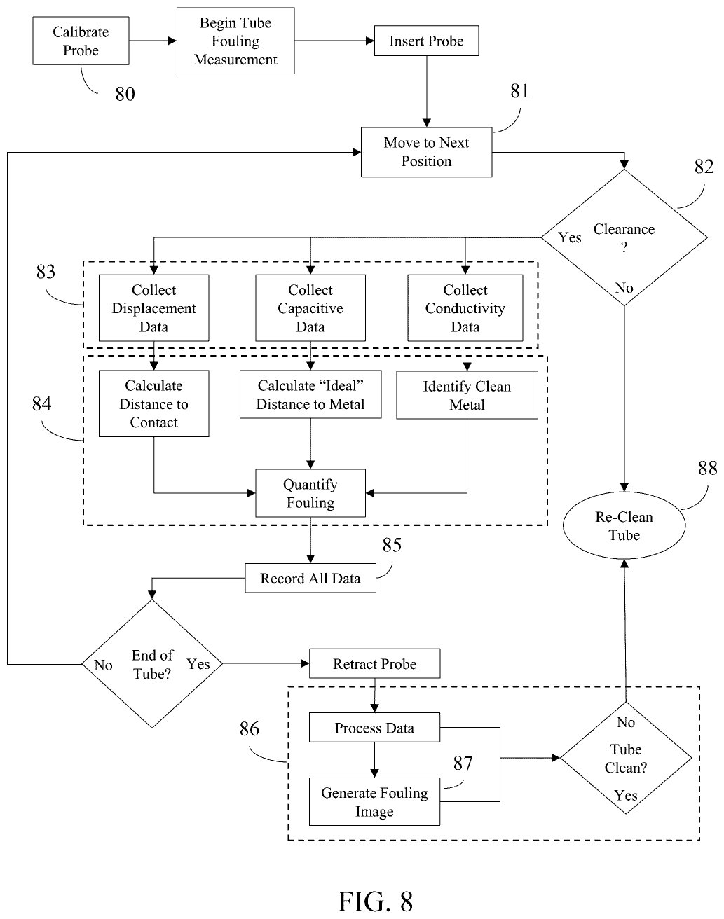

FIG. 8 is a flow diagram illustrating one example of a method for detecting internal tube fouling 24 by means of employing at least one of the probes disclosed herein. Following calibration at block 80, probe 70 may be inserted into bore 23 of tube 21 at tube sheet 15 shown in FIG. 1.

At block 81, probe 70 may be moved to the initial inspection position. If the probe is unable to be inserted to the initial inspection position, then there is sufficient fouling 24 such that the effective diameter is less than the diameter of probe body 71.

At decision block 82, a determination is made as to whether the probe 70 has sufficient clearance to move. Failure of a clearance test at block 82 indicates that tube re-cleaning 88 is necessary. If the clearance test at block 82 is passed and probe 70 can be moved into the initial test position, then measurements are performed at block 83.

At block 84, the data from the one or more sensors used to collect measurements in block 83 is processed and integrated to quantify fouling. As shown in FIG. 8, the manner in which the fouling is quantified may be based on the type of one or more sensors that are provided on a probe. The one or more sensors may provide data to a processor, such as processor 107 shown in FIG. 10, which may receive the data from the one or more sensors and determine an amount of fouling present on the inner surface of the tube at the location. In some embodiments, the amount of fouling may include a depth of the fouling. In some embodiments, the amount of fouling may include a percentage of the inner tube that is covered by fouling at a specific location. For example, an optical sensor 79 may be configured to rotate in a complete circle thus report data that may be used to determine the percentage of the inner tube that is covered by fouling at the first location. In some embodiments, the amount of fouling may include both a depth of the fouling and a percentage of the inner tube that is covered by fouling. One of ordinary skill in the art will understand that the data may be used to determine other characteristics of the fouling.

At block 85, the data is recorded 85, and a decision is made as to whether the probe 70 is located at or has reached the end of the tube 12. If the probe 70 has not reached the end of the tube 12, then the process moves back to block 81 at which time the probe is moved or otherwise advanced to the next sensor position. When the determination is made that the probe 70 has reached the end of the tube 12 or the end of the inspection region is reached, then the probe may be retracted.

At block 86, the data obtained by the probe during the inspection may be processed into at least one of a one-dimensional and two-dimensional image representative of fouling 24 in tube 12. In some embodiments, the image is generated incrementally as probe 70 is moved through the tube 12.

Also at block 86, a decision may be made, either by the operator or by the system using at least one of minimum fouling thresholds and artificial intelligence, as to whether or not remedial cleaning should be performed at block 88. For example, the system may compare the amount of fouling determined to be present at a location along a length of the tube to a threshold value to make the decision. The threshold value may include a depth of the fouling, a percent coverage of the value, and/or both a depth and a percent coverage. Other thresholds also may be used as will be understood by one of ordinary skill in the art. In some embodiments, weights may be applied to the determined values such that the determination as to whether remedial cleaning should be performed is based on a weighted calculation. For example, a depth of the fouling may be weighted more than a percent coverage of fouling, or vice versa.

Depending on the system, multiple thresholds may be used for a single measurement type. For example, a first depth threshold may be used when a first percent coverage threshold is met and/or exceeded, and a second depth threshold may be used when the first percent coverage threshold is below or at the first percent coverage threshold. In such a configuration, deeper fouling may not trigger a need to perform remedial cleaning if the fouling is localized (e.g., at or below a certain threshold of percent fouling). Conversely, if the fouling is not localized (e.g., the percent fouling is at or greater than a certain threshold), then a smaller depth of fouling may trigger a need to perform remedial cleaning. One of ordinary skill in the art will understand that there may be various ways to configure the system and/or determine whether remedial cleaning is suggested or needed.

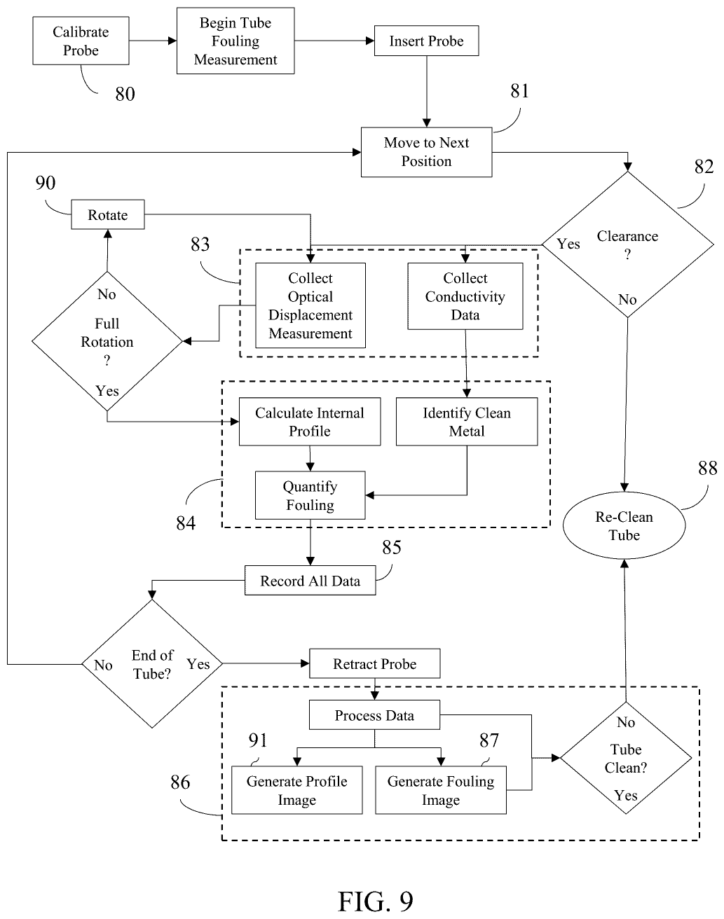

FIG. 9 is a flow diagram illustrating another example of a method for detecting internal fouling 24. The method or process shown in FIG. 9 differs from the method illustrated in FIG. 8 primarily in the measurement performed at block 83 and the fouling quantification performed at block 84. In the example illustrated in FIG. 9, the measurement performed at block 83 at least partially comprises collecting optical distance measurements using sensor 79. Sensor 79 may be rotated around the circumference of tube 12 at block 90 prior to movement to the next measurement position at block 81.

At block 86, the data may be processed, and an image of the internal profile of fouling 24 and inner tube surface 21 as measured by optical sensor 79 and a representative image 87 of fouling 24 may be generated at block 91. The image generated at block 91 may be a plot of the innermost surface of fouling 24, inner tube surface 21, or a combination thereof, as measured by a contact displacement sensor 77 or optical sensor 79. In circumstances in which corrosion, erosion, or other means of wall loss are present in tube wall 20, the image generated at block 91 may also provide non-destructive testing information on said wall loss.

A fouling image, which may be a plot of quantified fouling thickness 26 as a function of position along at the tube axis and, in some embodiments, the circumference, may be generated at block 87. Alternatively, the fouling image may be a plot indicating the locations in which the fouling thickness 26 exceeds a minimum value. In some embodiments, the fouling image generated at block 87 may be a plot of bare metal exposed on tube surface 21 as determined by conductivity sensor 60.

Data from a plurality of types of sensors in probe 70, including but not limited to a capacitive point sensor 76, a displacement sensor 77, a capacitive area sensor 78, and an optical distance sensor 79 can be combined, compared, and integrated to improve fouling quantification.

The block diagram in FIG. 10 illustrates one example of the relationship of various components in one embodiment of a system. The sensors 30, 40, 50, and 60, encoder 102, and other devices in probe 70 may be configured to be in signal communication with a controller 103, which may include at least one analog I/O device 104, digital I/O device 105, diagnostic electrical circuit 106, processor 107, memory 108, and graphical user interface 109, all or some of which may be located outside of a tube by means of cable 72. The at least one processor 107 may be configured to perform all or part of the methods described above with respect to FIGS. 8 and 9. The user interface 109 may include a mouse, touchpad, trackball, keyboard, microphone, speakers, and/or a display device. As will be understood by one of ordinary skill in the art, in some embodiments, the display device may be a touch screen display device that enables a user to input and view data.

The disclosed probes, systems, and methods can be embodied in the form of methods and apparatus for practicing those methods. The present invention can also be embodied in the form of program code embodied in tangible media, such as floppy diskettes, CD-ROMs, DVD-ROMs, Blu-ray disks, hard drives, or any other machine-readable storage medium, wherein, when the program code is loaded into and executed by a machine, such as a computer or processor, the machine becomes an apparatus for practicing the invention. The present invention can also be embodied in the form of program code, for example, whether stored in a storage medium, loaded into and/or executed by a machine or processor, or transmitted over some transmission medium, such as over electrical wiring or cabling, through fiber optics, or via electromagnetic radiation, wherein, when the program code is loaded into and executed by a machine, such as a computer or processor, the machine becomes an apparatus for practicing the invention. When implemented on a general-purpose processor, the program code segments combine with the processor to provide a unique device that operates analogously to specific logic circuits.

The foregoing outlines features of several embodiments so that those skilled in the art may better understand the aspects of the present disclosure. Those of ordinary skill in the art should appreciate that they may readily use the present disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a sensor including:
a body sized and configured to be received in a tube, the body supporting at least one sensor configured to obtain data representing a fouling of an inner surface of the tube.

2. The system of claim 1, wherein the at least one sensor includes at least one of a capacitive sensor, a contact displacement sensor, a conductivity sensor, and an optical distance sensor.

3. The system of claim 1, wherein the tube is part of a heat exchanger.

4. The system of claim 1, further comprising a processor in communication with the at least one sensor, the processor configured to:
receive the data representing a fouling of the inner surface of the tube from the at least one sensor; and
determine a fouling level of the inner surface of the tube based on the data.

5. The system of claim 4, wherein the processor is configured to determine the fouling level without being influenced by the presence of fouling on an exterior surface of the tube.

6. A system for detecting fouling, the system comprising:
a probe, the probe including:
a body sized and configured to be received in a tube to be inspected,
a plurality of sensors supported by the body, each sensor of the plurality of sensors configured to obtain data representing a fouling of an inner surface of the tube; and
a cable configured to be coupled to the probe.

7. The system of claim 6, wherein the probe includes at least one centering mechanism configured to contact an inner surface of the tube to be inspected.

8. The system of claim 7, wherein the at least one centering mechanism includes a plurality of wheels that are biased to extend outwardly from the body of the probe.

9. The system of claim 7, wherein the at least one centering mechanism includes at least one contact-type displacement sensor extending outwardly from the body of the probe.

10. The system of claim 6, wherein the body of the probe has a cylindrical shape and includes a front face having an outer diameter that is less than a maximum outer diameter of the body of the probe.

11. The system of claim 10, wherein the body includes a front edge disposed between the front face and the maximum outer diameter of the body.

12. The system of claim 10, wherein the cable is configured to be coupled to the probe at an end that is opposite the front face.

13. The system of claim 12, wherein the cable is sufficiently rigid to advance the probe at least partially along a length of the tube to be inspected.

14. The system of claim 6, wherein the plurality of sensors includes at least one optical sensor, the at least one optical distance sensor supported by the body of the probe such that the a least one optical distance sensor is configured to measure a distance from the optical distance sensor to at least one of an inner surface of the tube to be inspected or a fouling disposed on a surface of the tube to be inspected.

15. The system of claim 14, further comprising a controller disposed in signal communication with the plurality of sensors, the controller including a processor configured to receive signals from the plurality of sensors and determine an amount of fouling present on the inner surface of the tube to be inspected.

16. The system of claim 15, wherein the processor is configured to:
generate at least one fouling image; and
cause the at least one fouling image to be displayed.

17. A method, comprising:
receiving, by a processor of a controller, first data from at least one sensor supported by a body of a probe, the first data acquired by the at least one sensor when the probe is disposed within a tube and located at a first location along a length of the tube;
quantifying, by the processor based on the first data received from the at least one sensor, an amount of fouling present at the first location along the length of the tube; and
storing data indicative of the amount of fouling present at the first location along the length of the tube in a memory.

18. The method of claim 17, further comprising:
comparing, by the processor, the first data indicative of the amount of fouling present at the first location along the length of the tube to at least one threshold; and
determining whether the tube needs to be cleaned based on the comparing.

19. The method of claim 17, further comprising:
generating, by the processor based at least in part on the first data, at least one fouling image; and
causing the at least one fouling image to be displayed.

20. The method of claim 17, further comprising:
receiving, by the processor, second data from the at least one sensor supported by the body of the probe, the second data acquired by the at least one sensor when the probe is disposed within the tube and located at a second location along the length of the tube, the second location different from the first location;
quantifying, by the processor based on the second data received from the at least one sensor, an amount of fouling present at the second location along the length of the tube; and
comparing, by the processor, the second data indicative of the amount of fouling present at the second location along the length of the tube to the at least one threshold; and
determining whether the tube needs to be cleaned based on the comparing of the second data to the at least one threshold.
